(19) United States
(12) Patent Application Publication
(10) Pub. No.: US 2020/0053840 A1
(43) Pub. Date: Feb. 13, 2020

(54) HEATING MECHANISM FOR TOOLS

(71) Applicant: Jeptha Byars, Tulsa, OK (US)

(72) Inventor: Jeptha Byars, Tulsa, OK (US)

(21) Appl. No.: 16/102,658

(22) Filed: Aug. 13, 2018

(51) Int. Cl. H05B 6/10; B25B 13/56; B25H 3/04; G06F 1/26

(52) U.S. Cl. CPC H05B 6/101; G06F 1/266; B25H 3/04; B25B 13/56

(57) ABSTRACT

A tool rack includes: a first steel plate; a second steel plate, wherein each steel plate includes a cooperating receiving rack for wrenches; a power source attached to each plate; a first charge on the first plate; and a second charge on the second plate. The cooperating racks include a first receiving rack and a second receiving rack, wherein a rubber divider lies between the first steel plate on a first side and the second steel plate on a second side. A hole is provided in each plate for mounting purposes. The tool rack also includes a USB connector, where the USB connector supplies power for application of an electrical charge to each side of the tool rack.

### BACKGROUND OF THE INVENTION

### Field of Invention

The heating mechanism used for tools in particular wrenches.

### Description of Related Art

Small hand tools are used by many workers and former mechanic construction people or other professions. These hand tools may be used to perform work that involves screwing or adjusting bolts, etc. Small hand tools are typically made of metal in the form of steel or aluminum and therefore can be influenced by temperature. Some workers that work in outdoor areas and in particularly a cold environment. As such metal tools become cold in such environments. Cold metal tools are a little bit more difficult to maneuver, if the individual needs to wear gloves and such use diminishes the dexterity related to use of the tool. As a result, it would be advantageous to have a device that could be used to warm or keep the metal tools warm in a cold environment.

The object of the present invention is to provide a heating mechanism, which is specifically designed to store and mount tools in the form of wrenches where heat is transferred to tools and the temperature of the tools are regulated.

### SUMMARY OF THE INVENTION

The present invention relates to a tool rack includes: a first steel plate; a second steel plate, wherein each steel plate includes a cooperating receiving rack for wrenches; a power source attached to each plate; a first charge on the first plate; and a second charge on the second plate. The cooperating racks include a first receiving rack and a second receiving rack, wherein a rubber divider lies between the first steel plate on a first side and the second steel plate on a second side. A hole is provided in each plate for mounting purposes. The tool rack also includes a USB connector, where the USB connector supplies power for application of an electrical charge to each side of the tool rack.

### BRIEF DESCRIPTION OF DRAWINGS

FIG. 1 depicts a first embodiment of a tool heating mechanism according to the present invention.

### DETAILED DESCRIPTION

The present invention relates to a rack that is mounted on a wall or other flat surface that provides heating sensations for tools placed in the rack. In particular the present invention is designed and adapted for receiving wrenches. The rack includes a series of open slots that receive wrenches along the length of the rack. The rack is mounted on a flat surface and includes a steel plate on each side thereof. A rubber backing is provided and a center rubber divider is also provided on the rack. The rack is heated by applying an electrical charge to plates which comprise the rack. A USB cord provides power for application of a charge to each respective plate. The application of the charge radiates heat along the steel plates of the rack.

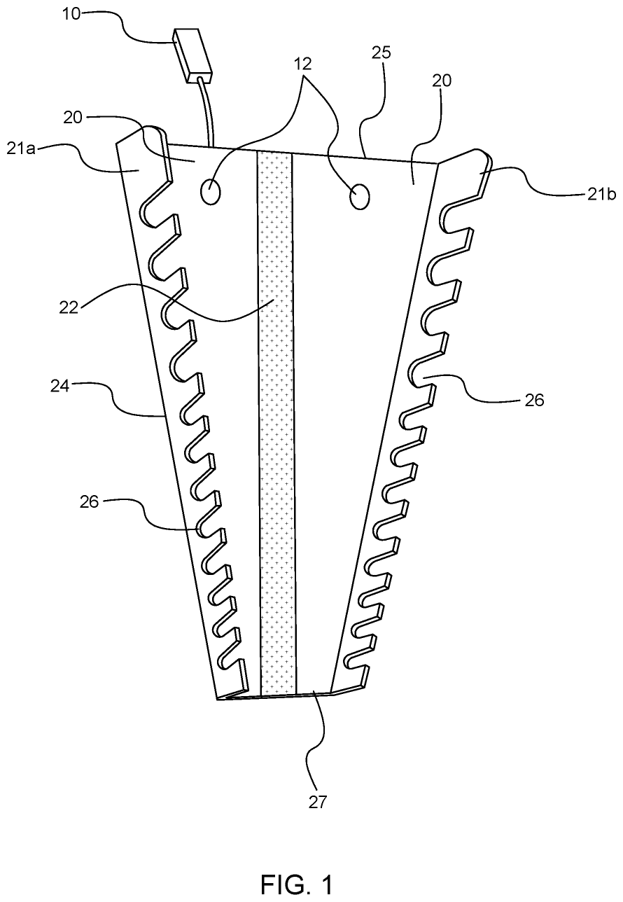

With respect to FIG. 1, a tool rack according to the present invention is depicted. The tool rack of FIG. 1 includes the first steel plate and second steel plate 20 as shown. These steel plates 20 include cooperating receiving racks for wrenches. A first receiving rack 20a and a second receiving rack 20b are shown on each side of the tool rack. The receiving racks 20a, 20b extend from each respective steel plate 20. The first steel plate 20 is on a first side and the second steel plate 20 is on a second side of a rubber divider 22. The rubber divider 22 separates the steel plates 20 and divides the first half of rack from the second half of the steel rack. A hole is provided in each plate, hole 12, for mounting purposes. USB Connector 10 is supplies power for application of an electrical charge to each side of the tool rack. Tools are received in openings 26 along each respective rack, 21a, 21b. The back side 24 not shown includes a rubber backing that provides padding and insulation for each respective steel plate. The charging associated with the steel plates 20 include a positive charge applied to the first side and a negative charge applied to the second side. At a top edge 25 a first width of the rack is depicted and the second width is depicted at the lower Edge 27. The width changes gradually to provide adequate or suitable widths for a wrench set with smaller wrenches placed at the lower end and larger wrenches are placed at the top end.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A tool rack comprising:
a. a first steel plate;
b. a second steel plate, wherein each steel plate includes a cooperating receiving rack for wrenches;
c. a power source attached to each plate;
d. a first charge on the first plate; and
e. a second charge on the second plate.

2. The tool rack according to claim 1, where the cooperating racks include a first receiving rack and a second receiving rack.

3. The tool rack according to claim 1, further including a rubber divider between the first steel plate on a first side and the second steel plate on a second side.

4. The tool rack according to claim 1, further including a hole in each plate for mounting purposes.

5. The tool rack according to claim 1, further including a USB connector, where the USB connector supplies power for application of an electrical charge to each side of the tool rack.
